(19) United States
(12) Patent Application Publication
(10) Pub. No.: US 2024/0153711 A1
(43) Pub. Date: May 9, 2024

(54) METHOD FOR MANUFACTURING MULTILAYER CERAMIC ELECTRONIC COMPONENT

(71) Applicant: KYOCERA Corporation

(72) Inventor: Hisashi SATO, Kirishima-shi (JP)

(73) Assignee: KYOCERA Corporation, Kyoto-shi, Kyoto (JP)

(21) Appl. No.: 18/282,060

(22) PCT Filed: Mar. 23, 2022
(86) PCT No.: PCT/JP2022/013728

§ 371 Date: Sep. 14, 2023

(30) Foreign Application Priority Data
Mar. 25, 2021 (JP) 2021-052368
Mar. 25, 2021 (JP) 2021052368

(51) Int. Cl. H01G 4/30; H01G 4/012; H01G 4/12; H01G 13/00

(52) U.S. Cl. CPC H01G 4/30; H01G 4/012; H01G 4/12; H01G 13/00

(57) ABSTRACT

A multilayer base including a plurality of dielectric ceramic bodies and internal electrode layers alternately stacked on one another is cut. Dry ice microparticles having a mean grain size not greater than 200 μm are caused to hit a cut surface including the internal electrode layers exposed to remove foreign matter on the cut surface.

The present disclosure relates to a method for manufacturing a multilayer ceramic electronic component including side margin portions that are added.

### BACKGROUND OF INVENTION

A known technique is described in, for example, Patent Literature 1.

### CITATION LIST

### Patent Literature

Patent Literature 1: Japanese Unexamined Patent Application Publication No. 2017-120880

### SUMMARY

In an aspect of the present disclosure, a method for manufacturing a multilayer ceramic electronic component includes cutting a multilayer base including a plurality of dielectric ceramic bodies and internal electrode layers alternately stacked on one another, and causing dry ice microparticles having a mean grain size not greater than 200 μm to hit a cut surface including the internal electrode layers exposed and removing foreign matter on the cut surface.

In the above aspect of the present disclosure, the above method for manufacturing a multilayer ceramic electronic component causes dry ice microparticles used for cleaning and polishing using dry ice to finally turn into CO₂ gas that is released into the air. This method thus eliminates a drying process and treatment of waste water or waste liquid.

The dry ice microparticles are softer than typical abrasives and thus allow cleaning and polishing with less damage on a relatively soft surface such as an internal electrode-exposed surface containing ceramic powder or metal particles and a resin binder. Such microparticles also allow cleaning and polishing in smaller areas.

### BRIEF DESCRIPTION OF THE DRAWINGS

FIG. 1 is a perspective view of a multilayer ceramic capacitor according to a first embodiment of the present disclosure.

FIG. 2 is a perspective view of a base component.

FIG. 3 is a perspective view of a base precursor.

FIG. 4 is a schematic perspective view of a ceramic green sheet on which a conductive paste is printed.

FIG. 5 is a schematic external view of stacked green sheets on some of which internal electrode layers are printed.

FIG. 6 is a perspective view of a multilayer base.

FIG. 7 is a perspective view of multiple rods cut from the multilayer base.

FIG. 8 is a perspective view of the multiple rods that are rotated to have a pair of side surfaces facing in the vertical direction and arranged densely in contact with one another in the width direction.

FIG. 9 is a schematic diagram describing a method of cleaning and polishing using dry ice in a second embodiment.

FIG. 10A is an enlarged view describing the method of cleaning and polishing using dry ice.

FIG. 10B is an enlarged view describing the method of cleaning and polishing using dry ice.

FIG. 11 is a schematic diagram describing a method of cleaning and polishing using dry ice in a third embodiment.

FIG. 12 is a plan view of FIG. 11.

FIG. 13 is a perspective view of rods that are arranged.

FIG. 14 is a perspective view of the rods to which protective sheets are attached.

FIG. 15 is a perspective view of cut base components.

FIG. 16 is a table comparing the effectiveness of different types of dry cleaning.

### DESCRIPTION OF EMBODIMENTS

The objects, features, and advantages of the present disclosure will become more apparent from the following detailed description and the drawings.

Recent small and highly functional electronic devices incorporate smaller electronic components. Examples of such multilayer ceramic electronic components include multilayer ceramic capacitors that typically have a size of 1 mm or less on each side. The electronic components are to be smaller and to have a larger capacity.

Thus, a multilayer ceramic capacitor may include enlarged internal electrodes and thinner side margin portions for insulation around the internal electrodes.

To allow side margin portions to be thinner, a stack of dielectric green sheets and internal electrodes stacked on one another may be cut to form multilayer chips including the internal electrodes exposed on their side surfaces. Thin side margin portions may then be added on the side surfaces of the multilayer chips for insulating the internal electrodes.

This method involves removing any foreign matter such as cutting debris resulting from cutting the stacked sheet. When a protective layer as a margin layer is formed on the cut surface with foreign matter remaining on the exposed internal electrodes, the protective layer can have pores corresponding to the foreign matter or can cause short-circuiting between the internal electrodes.

Patent Literature 1 describes methods for preventing such short-circuiting between internal electrodes on the side surface of a multilayer chip by removing a surface layer on the side surface of the multilayer chip having side margin portions to remove extended portions of internal electrode layers resulting from cutting the stacked sheet or to remove foreign matter on the internal electrodes. More specifically, the methods described in the literature remove the surface layer by grinding the side surface, removing the surface layer by blasting on the side surface, and removing the surface layer by applying a laser beam to the side surface.

However, these methods have the issues described below. The method for removing the surface layer by grinding the side surface of a multilayer chip uses a grinder disk rotated to grind the side surfaces of many multilayer chips that are aligned with one another. To grind the multilayer chips that may have varying dimensions, the grinder disk is to have the grinding depth of at least several tens of micrometers. This grinding depth is larger than the thickness of side margin portions that are added. Smaller chips have more material to be wasted.

The method for removing the surface layer by blasting on the side surface of a multilayer chip can involve water entering raw chips including ceramic green sheets to cause wetting or elution of their components. This method can also cause abrasive grains used in blasting to remain on the surfaces of the multilayer chips or to enter the multilayer chips. The components of the blasting abrasive grains can react with the dielectric ceramic during firing and can deteriorate the characteristics of the multilayer chips.

Although such blasting is described in detail and is followed by a sentence stating that dry ice may be used (paragraph 0084 in the specification), its principle, method, or effectiveness remains unexplained in the literature.

The method for removing the surface layer by applying a laser beam to the side surface uses a stronger laser beam with a smaller spot diameter. This increases the scanning distance to process the entire target surface. A laser beam with a larger spot diameter can be weak and is to be applied more times. A laser processing apparatus including an optical system with laser oscillation or an advanced pulse generator is costly and causes a large manufacturing burden.

In response to the above, one or more embodiments of the present disclosure are directed to a method for manufacturing a multilayer ceramic electronic component on which side margins can be added at low cost without causing pores, short-circuiting, or reaction with foreign matter.

A method for manufacturing a multilayer ceramic capacitor 1 will now be described as an example of a method for manufacturing a multilayer ceramic electronic component according to a first embodiment of the present disclosure. The manufacturing method according to one or more embodiments of the present disclosure may be applicable to multilayer ceramic electronic components other than the multilayer ceramic capacitor 1. One or more embodiments of the present disclosure will now be described with reference to the drawings.

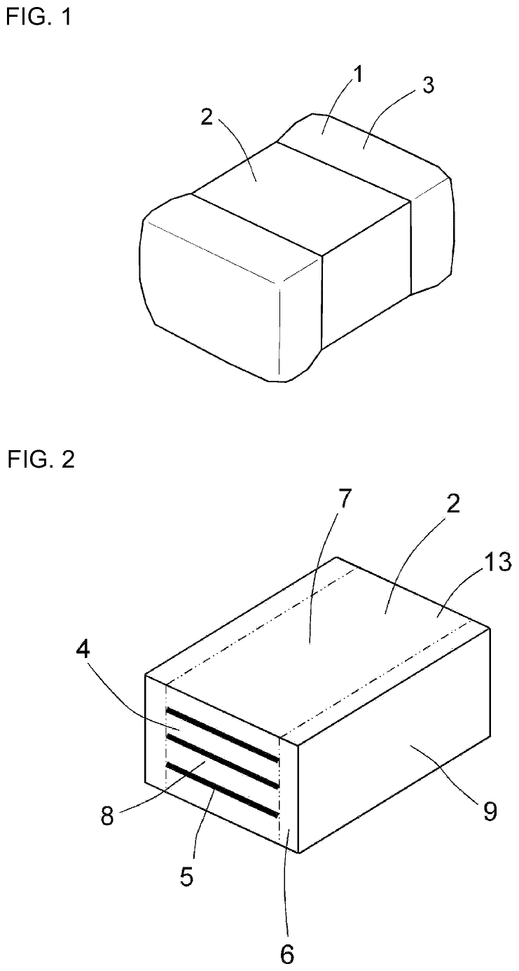

The multilayer ceramic capacitor 1 will now be described. FIG. 1 is a perspective view of an example multilayer ceramic capacitor 1. FIG. 2 is a perspective view of a base component 2. The multilayer ceramic capacitor 1 includes, as a main component, the base component 2 being a dielectric ceramic body 4 including internal electrode layers 5 inside, and external electrodes 3 on two end faces 8 of the base component 2. The external electrodes 3 on the end faces 8 extend to other surfaces, or main surfaces 7 and side surfaces 9 adjacent to the end faces 8.

The external electrodes 3 each include an underlayer connecting to the base component 2 and a plating outer layer to facilitate soldering. The underlayer is applied and fired after the chip is fired. In some embodiments, the underlayer may be placed before the chip is fired and then fired together with the main components. The underlayer or the plating layer may include multiple layers for intended functions. The plating layer may be replaced with a conductive resin layer.

FIG. 2 is a diagram of the base component 2 before firing, as well as after firing. The base component 2 is sintered and shrunk when fired with its structure maintained before and after firing. The base component 2 is substantially rectangular. The base component 2 includes a pair of main surfaces 7 opposite to each other, a pair of end faces 8 opposite to each other, and a pair of side surfaces 9 opposite to each other. The base component 2 includes the internal electrode layers 5 connected to the external electrodes 3 on the end faces 8. The internal electrode layers 5 extend inward from the pair of end faces 8 and are alternately stacked without being in contact with one another.

The boundaries between a stacked base precursor 13 and protective layers 6 adjacent to the side surfaces 9 are indicated by the dotted lines on the base component 2 in FIG. 2 for ease of explanation. However, the boundaries actually appear unclear. The protective layers 6 are added to the base precursor 13 to protect the internal electrode layers 5 exposed on the side surfaces 9. The protective layers 6 that are insulating may be made of a ceramic material that has mechanical strength and can be sintered together with the base precursor 13. For multilayer ceramic electronic components, the protective layers 6 are typically placed on the base component 2 before firing.

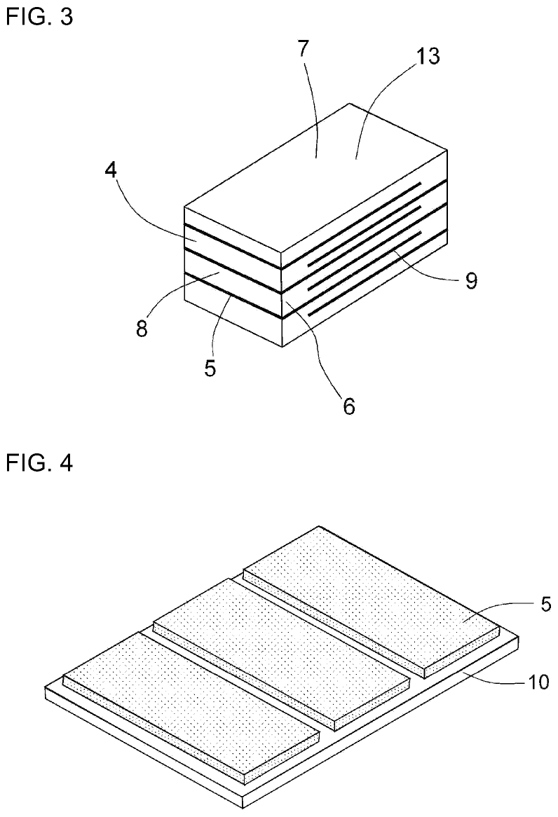

FIG. 3 illustrates the base precursor 13. The internal electrode layers 5 are exposed on the end faces 8 and the side surfaces 9. The internal electrode layers 5 exposed on the side surfaces 9 are two types of internal electrode layers 5 stacked on one another with the dielectric ceramic body 4 in between. Adjacent internal electrode layers 5 are not to be short-circuited. The protective layers 6 are to be added on the side surfaces 9 for electrical insulation and physical protection in a later process.

The base precursor 13 in FIG. 3 is likely to have debris from cutting or other foreign matter adhering on the side surfaces 9. This can cause short-circuiting between the two types of internal electrode layers 5 that are alternately adjacent to one another and exposed on the side surfaces 9. Such foreign matter on the side surfaces 9 as cut surfaces is to be removed. In one or more embodiments of the present disclosure, cleaning and polishing using dry ice microparticles that are solid but evaporate after cleaning and polishing are noted to be effective.

Cleaning and polishing using dry ice microparticles will now be described using an example method for manufacturing the base component 2 for the multilayer ceramic capacitor 1 according to one or more embodiments of the present disclosure.

A ceramic mixture powder containing an additive and barium titanate as a material of the dielectric ceramic body 4 was wet-ground and mixed with a bead mill and then mixed with a polyvinyl butyral binder, a plasticizer, and an organic solvent to obtain ceramic slurry.

Ceramic green sheets were then prepared on a carrier film with a die coater. The ceramic green sheets have a thickness of 0.5 to 10 μm. Thinner ceramic green sheets allow a capacitor to have a larger capacitance. The ceramic green sheets may be prepared with, for example, a doctor blade coater or a gravure coater rather than a die coater.

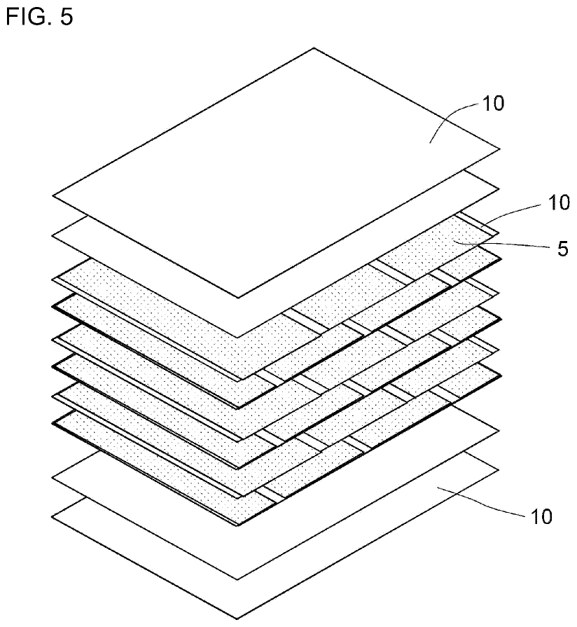

FIG. 4 is a schematic diagram of a ceramic green sheet on which a conductive paste is printed. As illustrated in FIG. 4, a conductive paste containing Ni was printed on a ceramic green sheet 10 in a strip pattern of multiple rows by gravure printing. The conductive paste is to be the internal electrode layers 5. The method of printing may be screen printing. The conductive paste may contain Pd, Cu, and Ag in addition to Ni, or may be an alloy containing one or more of these metals.

The thinner internal electrode layers 5 that maintain the characteristics as a capacitor may minimize internal defects caused by internal stress. In a capacitor having a stack of a large number of ceramic green sheets, each sheet may have a thickness not greater than 1.5 μm.

FIG. 5 is a schematic external view of stacked ceramic green sheets 10 on some of which the internal electrode layers 5 are printed. As illustrated in FIG. 5, a predetermined number of ceramic green sheets 10 are stacked on one another, a predetermined number of ceramic green sheets 10 on which the internal electrode layers 5 are printed are displaced from one another by half the size in the width direction of the internal electrode pattern and stacked on the top of the predetermined number of ceramic green sheets 10, and then a predetermined number of ceramic green sheets 10 are stacked on the top of the predetermined number of ceramic green sheets 10 on which the internal electrode layers 5 are printed. The sheets are stacked on a support sheet, although the support sheet is not illustrated in FIG. 5 for simplicity. The support sheet is an adhesive releasable sheet that is adhesive and releasable, such as a low-tack sheet or a foam releasable sheet.

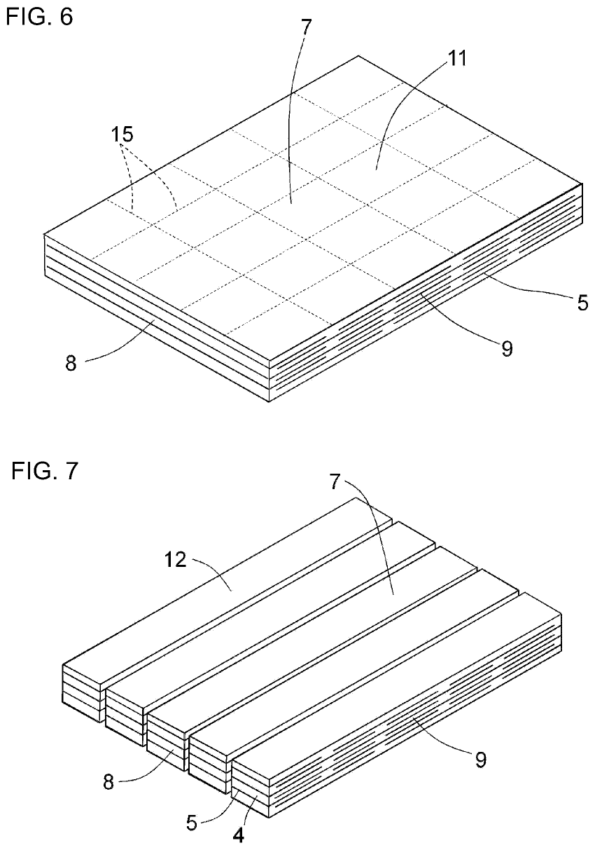

FIG. 6 is a perspective view of a multilayer base 11. The stack prepared in the stacking process was pressed in the stacking direction by hydrostatic pressing to obtain the integral multilayer base 11 illustrated in FIG. 6. The dotted lines on the surface of the multilayer base 11 are imaginary separation lines 15. Each stack separated by the imaginary separation lines 15 corresponds to the base precursor 13 in FIG. 3. The main surface 7, the end face 8, and the side surface 9 of the multilayer base 11 corresponds to the main surface 7, the end face 8, and the side surface 9 of the base precursor 13 in FIG. 3. Although not illustrated in the figure, the support sheet used in the stacking process is located on the bottom of the multilayer base 11 in this process as well.

FIG. 7 is a perspective view of multiple rods 12 cut from the multilayer base 11. The multilayer base 11 was cut to have predetermined dimensions with a dicing saw to obtain the rods 12 as illustrated in FIG. 7. The internal electrode layers 5 exposed on the cut surfaces correspond to the internal electrode layers 5 on the side surfaces 9 in FIG. 3. The cutting method is not limited to dicing saw cutting, and may be press cutting.

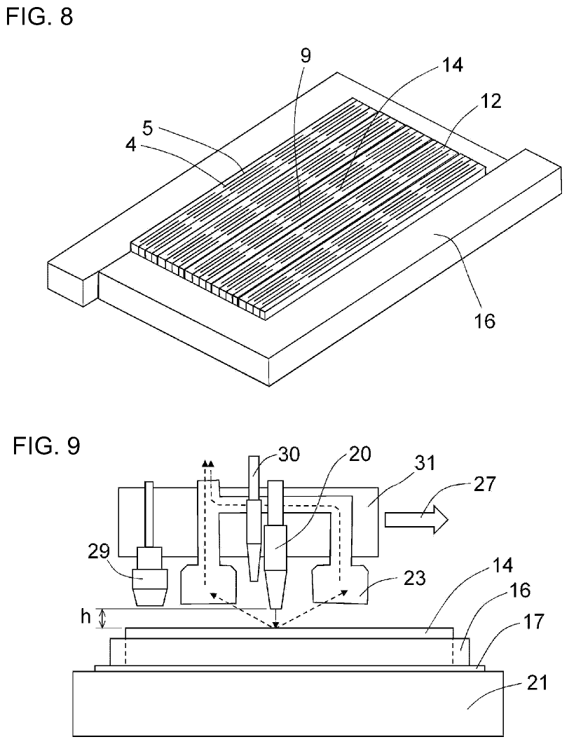

The rods 12 were reoriented to have the side surfaces 9 as internal electrode-exposed surfaces facing upward and arranged densely with L-shaped frames 16 into a rod assembly 14 as illustrated in FIG. 8. The rod assembly 14 includes a surface as an internal electrode-exposed surface to which the protective layer 6 is to be attached in the subsequent process. The rods may be densely arranged into the assembly by, for example, pressing the rods in four directions or tilting and placing the rods in one corner. Although not illustrated, an adhesive releasable sheet was then attached as a support sheet to one surface of the rod assembly 14 to retain its shape.

A second embodiment and a third embodiment will now be described as a method for removing foreign matter such as cutting debris on the surface of the rod assembly 14, or the internal electrode-exposed surface, by cleaning and polishing using dry ice microparticles.

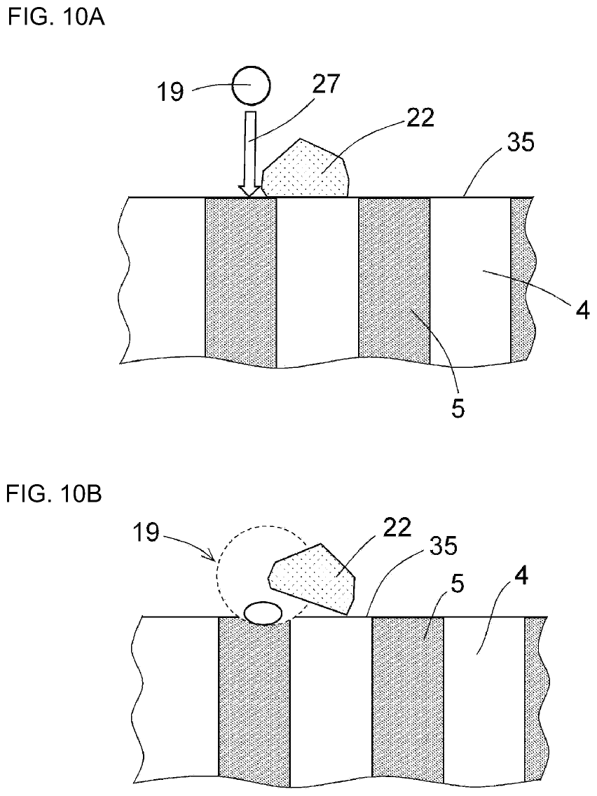

The second embodiment will be described. FIG. 9 is a schematic diagram describing a method of cleaning and polishing using dry ice in the second embodiment. FIGS. 10A and 10B are enlarged views describing the method of cleaning and polishing using dry ice. The rod assembly 14 is first fastened on a mount 21 with the internal electrode-exposed surface facing upward. In the present embodiment, the mount 21 including a suction unit (not illustrated) with multiple suction holes is used to hold the rod assembly 14. In some embodiments, for example, a mount with an embedded magnet may be used or a double-sided adhesive sheet may be used as a support to attach the rod assembly 14 to the mount. With the rod assembly 14 held on the mount 21, a dry ice nozzle 20 vertically ejects dry ice microparticles together with compressed air from its tip onto the internal electrode-exposed surface to clean and polish the internal electrode-exposed surface while scanning in a movement direction 27.

Coarse particles of dry ice obtained by shaving a dry ice block may hit one another under high pressure to form fine powder, which may then be ejected from the dry ice nozzle 20 as dry ice microparticles. Liquefied CO₂ filling a high-pressure cylinder may be fed to a special gun, converted into microparticles (powder) inside the special gun, and then ejected from the special gun together with compressed air. The dry ice microparticles are ejected in an atmosphere at normal temperature.

Ejecting dry ice in the vertical direction with respect to the internal electrode-exposed surface allows polishing of the internal electrode-exposed surface with an impact higher than when dry ice is ejected at an angle other than in the vertical direction.

As illustrated in FIGS. 10A and 10B, the dielectric ceramic body 4 containing a resin binder and dielectric ceramic powder and the internal electrode layers 5 containing a resin binder and metal powder are alternately exposed on a cut surface 35, which is an internal electrode-exposed surface. Dry ice microparticles 19 hitting the cut surface 35 clean and polish the cut surface 35 with the three effects described below and then completely turn into CO₂ gas and evaporate.

The first effect is polishing using hitting. The dry ice microparticles 19 are relatively soft unlike abrasive grains for blasting or other polishing and thus cause less damage on the soft cut surface 35. However, the dry ice microparticles 19 having a mean grain size greater than 200 μm may cause damage such as unevenness on the cut surface 35, possibly causing an attachment failure or voids when the protective layer 6 is placed.

The second effect is that the dry ice microparticles 19 expand 750 times when hitting the cut surface 35 and then turning into CO₂. When the dry ice microparticles 19 enter gaps adjacent to foreign matter 22, the dry ice microparticles 19 remove the foreign matter 22 with their expansion force.

The third effect is that the dry ice microparticles 19 partly liquefy and dissolve resin. For the foreign matter 22 adhering on the resin binder on the cut surface 35, the liquefied CO₂ dissolves the resin to remove the foreign matter.

A nozzle distance h between the tip of the dry ice nozzle 20 and the cut surface 35 illustrated in FIG. 9 is not less than 8 mm and less than 30 mm, and may be 20 mm. With the nozzle distance h of less than 8 mm, the cut surface 35 is cooled by a heat absorbing reaction that occurs when the dry ice microparticles 19 evaporate, thus causing condensation that prevents the jet flow of the dry ice from hitting the cut surface 35. With the nozzle distance h not less than 30 mm, the dry ice microparticles 19 evaporate before hitting the cut surface 35, thus reducing the polishing effect.

Movable suction ports 23 for dust are located adjacent to the dry ice nozzle 20 to maintain the blown foreign matter 22 to be away from the cut surface 35 as a target surface. The blown foreign matter is sucked through the suction ports 23. The suction ports 23 are attached to a nozzle fixing plate 31 to move together with the dry ice nozzle 20 at a predetermined distance from the dry ice nozzle 20.

The base of a multilayer ceramic component before firing includes a soft surface. The dry ice microparticles 19 having a mean grain size not greater than 200 μm were used. The dry ice microparticles 19 having a mean grain size of 200 μm or greater caused damage on the cut surface 35, which is the internal electrode-exposed surface, when the pressure was lowered to the minimum of 0.2 MPa to allow cleaning and polishing. More damage causes larger unevenness on the cut surface 35, causing voids when the protective layer 6 is attached to the cut surface 35. Such voids may cause the protective layer 6 to separate or reduce the insulation resistance. The dry ice powder may have various grain sizes not greater than 200 μm. Dry ice powder with a larger grain size may be used for coarse polishing, and dry ice powder with a smaller grain size may be used for finishing.

A method for measuring the grain size of dry ice will now be described. Dry ice powder is ejected using N₂ gas, and the dry ice microparticles are illuminated with light from a halogen lamp. The scattering light is then imaged with a high-speed microscope camera. The obtained image is analyzed to determine the grain sizes of the dry ice nanoparticles. The actual dry ice particles were not spherical but extended in the ejecting direction in the actual image of the particles. However, the particles were treated as being spherical, and the width of the flying particles was used as a particle diameter. Unfocused and blurred particle images or overlapping images were excluded from the measurement. Smoky substances possibly caused by cooling and condensing vapor in the air were also excluded. In this manner, 200 sets of particle data were collected, for which the arithmetic mean was calculated.

When compressed air is used to measure the grain size of dry ice, the vapor contained in the compressed air turns into micro ice grains having a diameter of several micrometers and appears like a mist. This mist-like ice can interfere the observation. Thus, N₂ gas was used in place of compressed air.

The grain size of the dry ice was measured at a position 20 mm away from the tip of the dry ice nozzle 20 in the ejecting direction of the dry ice microparticles.

Compressed air or nitrogen gas filling an N₂ cylinder is used as compressed gas to eject the dry ice microparticles from the dry ice nozzle 20. The maximum pressure for the gas is 0.6 MPa at an ordinary factory and are usually used at not greater than 0.5 MPa. The pressure lowered to 0.1 MPa does not allow polishing. The usable lowest pressure is 0.2 MPa.

With compressed air from a compressor, a compressed-air dehumidifier may be used to reduce the absolute water content in the compressed air. N₂ gas or CO₂ gas may be used in place of the compressed air. CO₂ gas easily penetrates resin and acts on the resin on which foreign matter adheres, facilitating removal of the foreign matter.

As illustrated in FIG. 9, a dry air nozzle 30 is located adjacent to the dry ice nozzle 20. When the dry ice microparticles 19 hit the cut surface 35 and then evaporate, the heat absorbing reaction lowers the temperature of the entire product. In other words, higher humidity causes condensation more easily on the cut surface 35 as a target surface. Dry air having a relative humidity not greater than 40% is fed from a dehumidifier to the cut surface 35, preventing condensation that can interfere cleaning and polishing using dry ice. In addition to air, N₂ gas or other gas may be fed to the cut surface 35.

A heater (not illustrated) is embedded in the mount 21 to heat the cut surface 35 for less condensation on the cut surface 35. The heater may not be embedded in the mount. For example, an IR heater may be located above the mount.

An electrostatic charge was observed on the cut surface 35 when the dry ice microparticles 19 hit the cut surface 35 and the foreign matter was removed. Ejecting the dry ice microparticles 19 onto the cut surface 35 at a higher gas pressure increases the electrostatic charge on the cut surface 35. In the present embodiment, an ionizer 29 that moves in synchronization with the dry ice nozzle 20 is located behind the dry ice nozzle 20 in the movement direction. The ionizer 29 can neutralize the static electricity by feeding antistatic-ion air immediately after the dry ice nozzle 20 ejects the dry ice microparticles 19. This prevents static electricity from attracting foreign matter back to the cut surface 35. An antistatic-ion gun having high air pressure may be used as the ionizer 29 to be more effective.

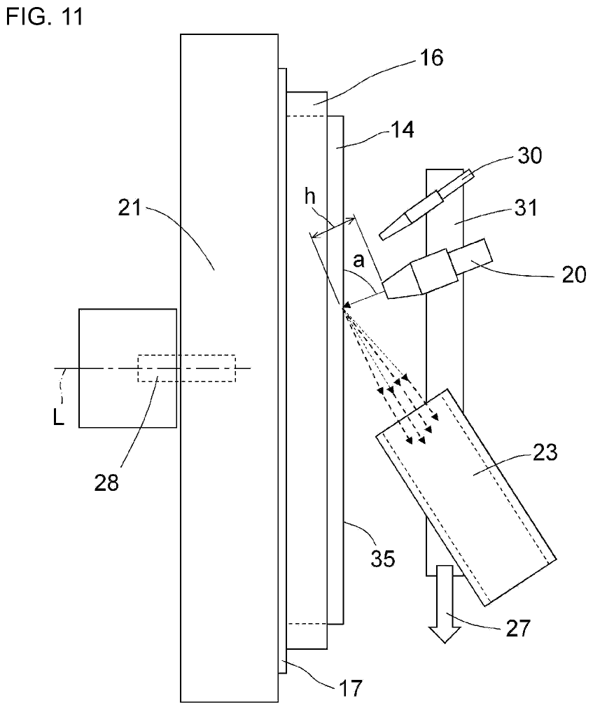

A method of cleaning and polishing using dry ice in the third embodiment will now be described. FIG. 11 is a schematic diagram describing a method of cleaning and polishing using dry ice in the third embodiment. In the present embodiment, the dry ice microparticles are ejected to hit the cut surface 35 at an acute angle between the ejecting direction in which the dry ice nozzle 20 ejects the dry ice microparticles 19 and the movement direction of the dry ice nozzle 20.

The cut surface 35 of the rod assembly 14 is located vertically, and thus foreign matter on the cut surface 35 blown by the dry ice microparticles 19 fall downward without returning to the cut surface 35 of the rod assembly 14. The cut surface 35 may be placed at an angle other than being vertical to prevent foreign matter from accumulating on the target surface.

The rod assembly 14 is fixed to a suction mount 21 including multiple suction holes (not illustrated) in its surface. The rod assembly 14 may be fixed to the suction mount 21 with a double-sided adhesive sheet as the support sheet (not illustrated).

The nozzle distance h between the tip of the dry ice nozzle 20 and the cut surface 35 is set to 20 mm as defined in the second embodiment. The angle a may be not less than 45 degrees and less than 90 degrees. The angle a less than 45 degrees reduces the polishing effect. The angle a of 90 degrees causes the polished foreign matter 22 to scatter in all directions. The dry ice nozzle 20 tilted at an angle slightly less than 90 degrees allows the foreign matter 22 to scatter downward. A suction port 23 for dust that moves at a predetermined distance from the dry ice nozzle 20 is fixed on the nozzle fixing plate 31 to quickly collect the foreign matter 22 scattering downward.

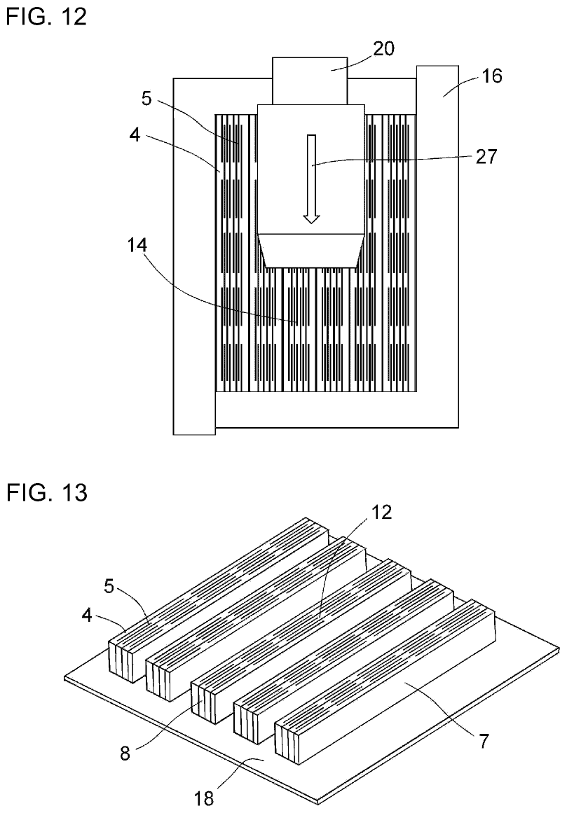

FIG. 12 is a plan view of FIG. 11. The rod assembly 14 is located with the longitudinal direction of the internal electrode layers 5 in the rod assembly 14 parallel to the movement direction of the dry ice nozzle 20. When the longitudinal direction of the internal electrode layers 5 is not parallel to the movement direction of the dry ice nozzle 20, deformation of an internal electrode layer 5 due to damage by the dry ice microparticles 19 may cause short-circuiting between the internal electrode layer 5 and an adjacent internal electrode layer 5. When the longitudinal direction of the internal electrode layer 5 is parallel to the movement direction of the dry ice nozzle 20, deformation of an internal electrode layer 5 does not cause another internal electrode layer adjacent to the internal electrode layer 5 to deform, reducing short-circuiting.

The mount 21 is rotatable by 180 degrees. After first cleaning and polishing, the mount 21 may be rotated by 180 degrees about a rotation axis L in the horizontal direction, and second cleaning and polishing may then be performed. Depending on the shape of foreign matter or the manner of adherence of the foreign matter, the tilted jet flow may be more effective when the second cleaning and polishing is performed in a direction opposite to the first cleaning and polishing.

The mount 21 with an embedded heater (not illustrated) is used. This prevents the temperature of the product surface from decreasing when the dry ice microparticles 19 hit the surface and evaporate, thus preventing condensation on the target surface. The product may be heated with an IR heater not included in the mount 21.

An ionizer 29 that moves synchronously is located above the dry ice nozzle 20. This prevents static electricity generated when dry ice hits the surface from attracting foreign matter back to the surface. Although the ionizer 29 feeds ion air in the present embodiment, an antistatic-ion gun may also be used in some embodiments. After the cleaning and polishing process on one surface of the rod assembly, a support sheet is attached to the surface, and then the assembly is flipped. The support sheet attached to the other surface is then released to expose the unprocessed surface, and the same process is performed on the surface. Two examples of cleaning and polishing using dry ice have been described.

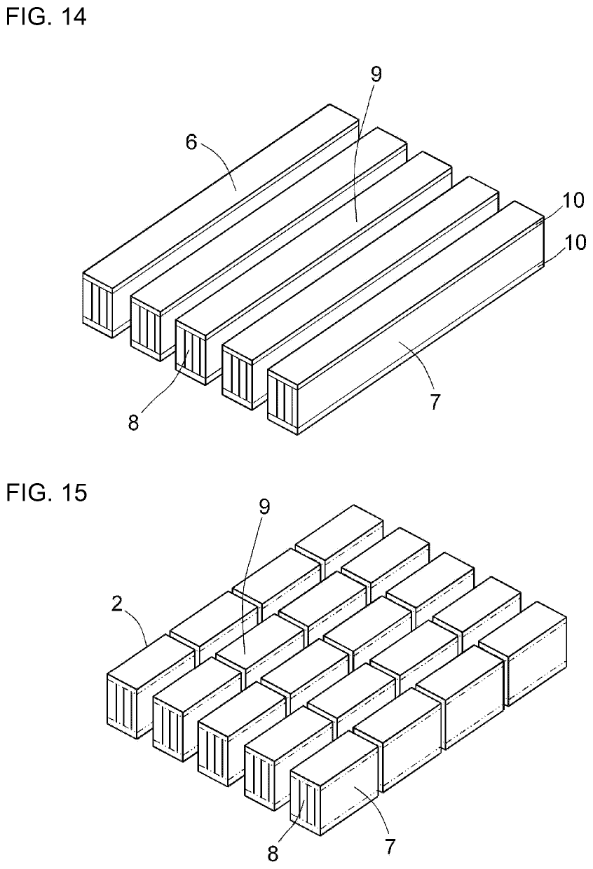

The rod assembly 14 was then moved onto an adhesive expansion sheet 18. The rods 12 were then spaced from one another as illustrated in FIG. 13. The ceramic green sheets 10 are then placed on the upper and lower surfaces of the rods 12 as illustrated in FIG. 14. The ceramic green sheets 10 serve as the protective layers 6. The ceramic green sheets 10 with the same composition as the ceramic green sheets used for the base component 2 were attached to have a predetermined thickness of 10 to 40 μm. When the protective layers 6 are to have additional functionality, sheets that contain a composition different from the ceramic green sheets used for the base component 2 may be used. A ceramic paste may be applied and dried to serve as a protective layer in place of the green sheets.

As illustrated in FIG. 15, the rods 12 including the protective layers 6 in FIG. 14 are then cut at predetermined positions to obtain the base components 2, which are chips.

The base components 2 in FIG. 15 are then placed on a zirconia plate, and degreased and fired. The base components 2 are placed into a degreasing furnace to remove the solvent and the binder and then sintered in a high-temperature firing furnace to obtain the sintered base components 2 as illustrated in FIG. 2. After the edges and the corners are rounded by barrel polishing or other techniques, the external electrodes 3 are attached in the final process to obtain the multilayer ceramic capacitors 1 as illustrated in FIG. 1.

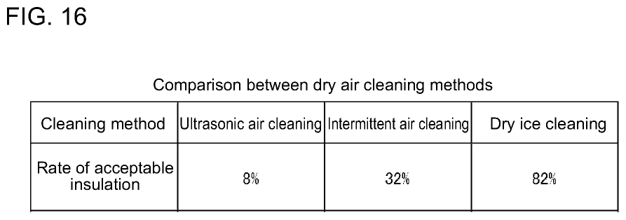

FIG. 16 is a table comparing the effectiveness of different types of dry cleaning. When immersed in water for a long time, multilayer ceramic electronic components swell and have defects such as delamination. Thus, the cleaning methods compared selectively use no water.

The ultrasonic air cleaning method uses an ultrasonic generator included in a nozzle to apply ultrasonic together with ejected air for cleaning and is effective for cleaning microparticles in several micrometers.

The intermittent air cleaning method quickly repeats turning on and off air ejected from a nozzle to shake off any adhering foreign matter. The methods were compared with each other under optimum conditions determined through preliminary experimentation.

More specifically, the ultrasonic air cleaning method uses an air pressure of 0.4 MPa, a nozzle distance of 20 mm, a speed of 10 mm/second, and 2 strokes for cleaning. The intermittent air cleaning method uses an air pressure of 0.5 MPa, intermittent air of 600 times/minute, a nozzle distance of 10 mm, a speed of 10 mm/second, and 2 strokes for cleaning.

The dry ice cleaning method uses an air pressure of 0.4 MPa, a nozzle distance of 20 mm, a speed of 10 mm/second, and 2 strokes for cleaning and polishing. As shown in the table in FIG. 16, the dry ice cleaning method shows more effective cleaning.

Although cleaning and polishing using dry ice follows the first cutting illustrated in FIG. 7 in the above embodiments, cleaning and polishing using dry ice may be performed on a stack after the first cutting illustrated in FIG. 7 and the second cutting illustrated in FIG. 15 perpendicular to the first cutting illustrated in FIG. 7. Although protective layers were placed after dry ice cleaning and polishing, other processing may be performed after the dry ice cleaning and polishing.

The present disclosure may be implemented in the following forms.

In one or more embodiments of the present disclosure, a method for manufacturing a multilayer ceramic electronic component includes cutting a multilayer base including a plurality of dielectric ceramic bodies and internal electrode layers alternately stacked on one another, and causing dry ice microparticles having a mean grain size not greater than 200 μm to hit a cut surface including the internal electrode layers exposed and removing foreign matter on the cut surface.

In one or more embodiments of the present disclosure, the above method for manufacturing a multilayer ceramic electronic component causes dry ice microparticles used for cleaning and polishing using dry ice to finally turn into CO₂ gas that is released into the air. This method thus eliminates a drying process and treatment of waste water or waste liquid.

The dry ice microparticles are softer than typical abrasives and thus allow cleaning and polishing with less damage on a relatively soft surface such as an internal electrode-exposed surface containing ceramic powder or metal particles and a resin binder. Such microparticles also allow cleaning and polishing in smaller areas.

### REFERENCE SIGNS

1 multilayer ceramic capacitor
2 base component
3 external electrode
4 dielectric ceramic body
5 internal electrode
6 protective layer
7 main surface
8 end face
9 side surface
10 ceramic green sheet
11 multilayer base
12 rod
13 base precursor
14 rod assembly
15 imaginary separation line
16 frame
17 support sheet
18 adhesive expansion sheet
19 dry ice microparticle
20 dry ice nozzle
21 mount
22 foreign matter
23 suction port
27 movement direction
28 rotational shaft
29 ionizer
30 dry air nozzle
31 nozzle fixing plate
35 cut surface
a angle
h nozzle distance
L rotation axis

1. A method for manufacturing a multilayer ceramic electronic component, the method comprising:
cutting a multilayer base including a plurality of dielectric ceramic bodies and internal electrode layers alternately stacked on one another; and
causing dry ice microparticles having a mean grain size not greater than 200 μm to hit a cut surface including the internal electrode layers exposed and removing foreign matter on the cut surface.

2. The method according to claim 1, wherein
the dry ice microparticles are caused to hit the cut surface being heated.

3. The method according to claim 1, wherein
the dry ice microparticles are caused to hit the cut surface being fed with dry air.

4. The method according to claim 1, wherein
the dry ice microparticles are ejected from a dry ice nozzle, and
a distance between a tip of the dry ice nozzle and the cut surface is not less than 8 mm and less than 30 mm.

5. The method according to claim 4, wherein
a suction port is located adjacent to the dry ice nozzle to move in synchronization with the dry ice nozzle.

6. The method according to claim 4, wherein
the dry ice nozzle ejects dry ice microparticles onto the cut surface while moving horizontally.

7. The method according to claim 4, wherein
the dry ice nozzle ejects dry ice microparticles onto the cut surface while moving vertically.

8. The method according to claim 6, wherein
an ionizer is located behind the dry ice nozzle in a direction in which the dry ice nozzle is movable, and
the ionizer feeds antistatic ions to the cut surface.

9. The method according to claim 6, wherein
the dry ice nozzle ejects dry ice microparticles in a direction at an acute angle with respect to a direction in which the dry ice nozzle is movable.

10. The method according to claim 6, wherein
the dry ice nozzle is movable in a direction parallel to a longitudinal direction of the internal electrode layers exposed on the cut surface.

11. The method according to claim 6, wherein
the cut surface is rotatable by 180 degrees about a rotation axis perpendicular to the cut surface, and the dry ice nozzle ejects dry ice microparticles while moving from a first end to a second end of the cut surface and ejects dry ice microparticles while moving from the second end to the first end of the cut surface rotated by 180 degrees about the rotation axis.
